(19) United States
(12) Patent Application Publication
(10) Pub. No.: US 2025/0277729 A1
(43) Pub. Date: Sep. 4, 2025

(54) APPARATUS, SYSTEM AND METHODS FOR TESTING A FILTER

(71) Applicant: HAMILTON ASSOCIATES, INC., Owings Mills, MD (US)

(72) Inventors: Ronald William Adkins, Monkton, MD (US); Mellissa Jamie Dalby, Baltimore, MD (US); Gautam Patel, Baltimore, MD (US); James Michael Power, Baltimore, MD (US)

(21) Appl. No.: 18/594,731

(22) Filed: Mar. 4, 2024

(51) Int. Cl. G01N 15/08; G06F 3/04817; G06F 3/0482; G06F 3/0484

(52) U.S. Cl. CPC G01N 15/0806; G01N 15/082; G06F 3/04817; G06F 3/0482; G06F 3/0484; G01N 2015/084

(57) ABSTRACT

A preferred form of the invention is directed to a system and method used to test filters in situ. The system preferably includes a base unit and a handheld probe operably associated with the base unit. The probe is configured to be deployed adjacent the filter being tested while the filter is located in an operating position. The handheld probe and/or base unit can be provided with a virtual or physical trim/rewind activation member to enable the user to erase scan data that the user knows is not reflective of filter leakage or filter efficiency or lack thereof of the filter being tested. The handheld probe and/or base unit can be provided with one or more interactive screens or graphical user interfaces including one or more virtual activation icons as opposed to physical activation members for performing numerous different functions associated with testing a filter in situ.

### FIELD OF THE INVENTION

Preferred forms of the present invention are directed to apparatus, systems and methods for testing a filter with a handheld scanning probe operably connected to a base unit. In the most preferred forms, the present invention is directed to apparatus, systems and methods for testing a filter in situ, i.e., the normal operating position of the filter. However, a filter system formed in accordance with an embodiment of the invention could be used to test filters at the manufacturing site or any other site in which the filter is not installed in an operating position.

One preferred form of the present invention significantly improves the process of testing a filter using a handheld scanning probe to scan the filter being tested by allowing the operator/user to erase, eliminate, disregard or discount that portion of a filter scan in which airborne particles are generated and detected by the handheld scanning probe that have nothing to do with the efficiency or leakage of the filter being tested.

This feature is particularly advantageous when during a filter scanning process, an operator using the handheld probe to scan a particular filter encounters a situation in which a condition is presented that will register a false failure of the filter being tested. For example, the operator may inadvertently hit or strike a portion of a bio safety cabinet housing the filter being tested or any other area surrounding the filter being tested that results in particles being generated and detected by the scanning probe that have nothing to do with the efficiency or effectiveness or leakage of the filter being tested that lead to a false finding or reading of a filter failure. Alternatively, during a filter scan, the operator or other individual in close proximity to the filter being tested may sneeze or cough generating particles detected by the scanning probe that have nothing to do with the efficiency or effectiveness or leakage of the filter being tested that lead to a false finding or reading of a filter failure. Various other events may generate airborne particles that are detected by the handheld scanning probe that have nothing to do with the efficiency or effectiveness or leakage of the filter being tested that lead to a false finding or reading of a filter failure.

A preferred form of the present invention includes a virtual or physical trim or rewind activation member or members that an operator and/or user can manipulate to eliminate, discount, erase or discard a predetermined portion of the filter scan (e.g., ten 10 seconds of the filter scan just prior to a user activating the trim or rewind member) including all scanning data associated with the predetermined portion of the filter scan to compensate for circumstances occurring during the predetermined portion of the filter scan in which airborne particles are generated and detected by the scanning probe that have nothing to do with the efficiency or leakage of the filter being tested during the predetermined portion of the filter scan while maintaining all scanning data for all portions of the filter scan other than the predetermined portion of the filter scan.

The trim or rewind activation member or members can be physical or virtual activation members on the handheld probe and/or the base unit.

In one preferred embodiment, all scanning data is collected after activation of the physical or virtual activation trim or rewind member or members on the handheld probe and/or the base unit so that inadvertent activation does not prejudice the completion of the filter scan. Specifically, in a preferred form of the invention, upon activation of the physical or virtual activation trim or rewind member or members on the handheld probe and/or the base unit, a pop-up window or other graphical interactive icon or element will be presented to the user/operator on the handheld probe and/or base unit asking the user/operator to cancel or confirm that the trim/rewind function is to be performed. In a preferred form, the system continues to collect all scan data subsequent to activation the trim or rewind member or members.

If the operator/user selects to cancel the rewind/trim function, the filter scan will proceed as if the trim/rewind function was never activated including recording all scan data subsequent to activation the trim or rewind member or members.

A preferred form of the system is configured such that where the filter system displays maximum filter leakage on the base unit and/or the handheld probe, if a maximum filter leakage occurs during the period from activation of the trim/rewind function and cancellation of the trim/rewind function, the maximum filter leakage during this period will be displayed on the handheld probe and/or base unit.

A preferred form of the system is configured such that where the operator/user confirms that the trim/rewind function is to be performed and the maximum leakage of the filter being scanned occurs during the time period to be discarded, erased, discounted or eliminated, the maximum leakage occurring immediately prior to the portion of the filter scan to be discarded, erased, discounted or eliminated will be displayed as the maximum leakage on the handheld probe and/or base unit.

A preferred form of the present invention includes replacing physical activation members on the handheld probe and/or the corresponding base unit with virtual activation members/icons/touch screen portions or sections.

Another preferred embodiment of the present invention includes methods, apparatus and systems in which one or more virtual icons that cannot be activated or are irrelevant to the current displayed interactive screen are not displayed on the current displayed interactive screen to the operator/user on the handheld probe or base unit or are automatically disabled when presented to the user.

A further preferred embodiment of the present invention includes methods, apparatus and systems configured to display in the same space, section or area of a screen or graphical user interface, multiple different activation icons having different functions (e.g., pause icon pausing the filter scan and start icon causing the scan to proceed). The detectable difference (e.g., background, shape or other differing characteristic) of one or more features of the displayed icons will dictate a particular action. For example, a first state of the filter system when the pause icon is activated will result in a particular functioning being performed and a second state of the filter system when the start icon is activated appearing in the same space on the display screen as the pause icon will result in another function, i.e., the system is able to detect differences in the state of the filter system when different activation members are activated and perform different functions due to the detected differences in the state of the filter system.

In a further preferred embodiment, the handheld probe is provided with a super capacitor to prevent loss of scanning data by providing the unit including the handheld probe sufficient time to store data and then shut down after the base unit has been disconnected from a power source, i.e., electrical outlet.

Another preferred embodiment, includes one or more interactive screens or graphical user interfaces having virtual icons that allow the user to perform functions that are relevant or related to a filter scan including: (i) setting or modifying security settings of the handheld probe like encrypting all files that are copied to an external storage device (e.g., USB stick or drive) connected to the handheld probe and password protecting any function or process in which password protection is desired (e.g., firmware updating, downloading or erasing date and entry or modifying the date and time).

### BACKGROUND OF THE INVENTION

Various devices have been used to test leakage of various filters employed in bio safety cabinets, pharmaceutical clean rooms, animal testing laboratories and nuclear environments. These devices have included photometers used in conjunction with aerosol generators to measure how well a filter is performing. Typically, an aerosol with a known concentration is introduced before or upstream of the filter and the photometer is operably connected to the downstream side of the filter to measure any leakage of the aerosol through the filter. Photometers typically utilize forward light scattering to measure any leakage of aerosol through the filter being tested.

Prior known devices can test both upstream and downstream samples. To test the upstream sample, a conduit is typically connected to a base unit with the open end of the conduit deployed upstream of the filter being tested. To test the downstream sample, prior known devices have used a handheld probe operably connected to the base unit. The probe is deployed on the downstream side of the filter and conveys the test sample back to the base unit to be processed to determine any leakage of aerosol through the filter.

Prior filter systems have been unable to allow the user to discard, eliminate or erase a portion of a filter scan where airborne particles are present and detected that never passed through the filter being tested but rather are due to other circumstance occurring during a filter scan. For example, the operator may inadvertently hit or strike a portion of a bio safety cabinet housing the filter being tested or any other area surrounding the filter being tested that results in particles being generated and detected by the scanning probe that have nothing to do with the efficiency or effectiveness or leakage of the filter being tested that lead to a false finding or reading of a filter failure. Alternatively, during a filter scan, the operator or other individual in close proximity to the filter being tested may sneeze or cough generating particles detected by the scanning probe that have nothing to do with the efficiency or effectiveness or leakage of the filter being tested that lead to a false finding or reading of a filter failure. Various other events may generate airborne particles that are detected by the handheld scanning probe that never passed through the filter being tested and, therefore, have nothing to do with the efficiency or effectiveness or leakage of the filter being tested that lead to a false finding or reading of a filter failure.

Also, prior handheld probes used in testing a filter in situ have physical activation members to allow the user to manipulate the functioning of the handheld probe and/or associated base unit before, during and after a filter scan. Due to size and weight constraints on handheld probes used to test filters in situ including filters in raised or elevated locations, the number of physical activations members on the handheld probe are or can be limited to prevent the handheld probe from being too large or too heavy.

Further, the display screens on prior handheld probe are small due to the need to have physical activation members on the handheld probe precluding presentation of numerous different graphical user interfaces having numerous different virtual interactive icons that can be activated merely be the user touching or tapping on a corresponding virtual interactive icon.

The prior art has other limitations and/or disadvantages that are overcome by preferred forms of the present invention.

### OBJECTS AND SUMMARY OF THE INVENTION

An object of a preferred embodiment of the present invention is to provide a novel and unobvious apparatus and/or process for testing filters.

Another object of a preferred embodiment of the present invention is to provide an apparatus for testing a filter in situ, i.e., the normal operating position of the filter.

A further object of a preferred embodiment of the present invention is to provide a handheld scanning probe and/or base unit configured to allow an operator/user to erase, eliminate, disregard or discount that portion of a filter scan (i.e., 10 seconds of a filter scan of an approximately five (5) minute filter scan for a 4′×2′ filter or 2.5 minutes of a filter scan for a 2′×2′ filter) in which airborne particles are generated and detected by the handheld scanning probe that have nothing to do with the efficiency or leakage of the filter being tested (e.g., airborne particles that never pass through the filter being tested).

Still another object of a preferred embodiment of the present invention is provide a handheld probe and/or base unit with a virtual or physical trim or rewind activation member or members that an operator and/or user can manipulate to eliminate, discount, erase or discard a predetermined portion of the filter scan (e.g., ten (10) seconds of the filter scan just prior to a user activating the trim or rewind member) including all scanning data associated with the predetermined portion of the filter scan to compensate for circumstances occurring during the predetermined portion of the filter scan in which airborne particles are generated and detected by the scanning probe that have nothing to do with the efficiency or leakage of the filter being tested during the predetermined portion of the filter scan while maintaining all scanning data for all portions of the filter scan other than the predetermined portion of the filter scan.

Still a further object of a preferred embodiment of the present invention is provide a filter testing system configured so that any and all scanning data is collected after activation of the physical or virtual activation trim or rewind member or members on the handheld probe and/or the base unit so that inadvertent activation does not prejudice the completion of the filter scan.

Yet still a further object of a preferred embodiment of the present invention is to provide a filter testing system configured such that upon activation of the physical or virtual activation trim or rewind member or members on the handheld probe and/or the base unit, a pop-up window or other graphical interactive icon will be presented to the user/operator on the handheld probe and/or base unit asking the user/operator to cancel or confirm that the trim/rewind function is to be performed and if the operator selects cancel, the filter scan will proceed as if the trim/rewind function was never activated including recording all scan data subsequent to activation of the trim or rewind member or members.

Yet another object of a preferred embodiment of the present invention is to provide a filter testing system configured such that configured if a maximum filter leakage occurs during the period from activation of the trim/rewind function and cancellation of the trim/rewind function, the maximum filter leakage during this period will be displayed on a display of the handheld probe and/or base unit.

Still a further object of a preferred embodiment of the present invention is to provide a system for testing a filter configured such that where the operator/user confirms that the trim/rewind function is to be performed and the maximum leakage of the filter being scanned occurs during the time period to be discarded, erased, discounted or eliminated, the maximum filter leakage occurring immediately prior to the portion of the filter scan to be discarded, erased, discounted or eliminated will be displayed as the maximum leakage on the handheld probe and/or base unit.

Another object on one preferred embodiment of the present invention is to provide a filter test system in which all physical activation members previously present on a handheld probe and/or a corresponding base unit with the sole exception being the on/off physical activation member of the base unit are replaced with virtual interactive activation members/icons/touch screen portions or sections presented on the display of the handheld probe and/or base unit.

A further object on one preferred embodiment of the present invention is to provide a filter test system in which one or more virtual icons that cannot be activated or are irrelevant to the current displayed interactive screen are not displayed on the current displayed interactive screen to the operator/user on the handheld probe and/or base unit or are automatically disabled when presented to the user.

Yet another object of one preferred embodiment of the present invention is to provide a filter test system configured to display in the same space, section or area of a screen or graphical user interface, multiple different activation icons having different functions (e.g., pause icon pausing the filter scan and start icon). A detectable difference (e.g., background or shape or other distinguishing characteristic) of one or more features of the displayed icons will dictate a particular action.

Still a further object of one preferred embodiment of the present invention is to provide a filter test system in which the handheld probe does not have any physical activation members but rather all activations that a user can activate on the handheld probe are virtual activation members presented on an interactive screen(s) or graphical user interface(s).

Yet still a further object of one preferred embodiment of the present invention is to provide a filter test system in which the handheld probe is provided with a super capacitor to prevent loss of scanning data when moving the filter system from one electrical outlet to another electrical outlet.

Yet another object of one preferred embodiment of the present invention is to provide a filter test system configured to display on the handheld probe and/or base unit one or more interactive screens or graphical user interfaces having virtual icons that allow the user to perform functions that are relevant or related to a filter scan including: (i) setting or modifying security settings of the handheld probe like encrypting all files that are copied to an external storage device (e.g., USB stick or drive) connected to the handheld probe and password protecting any function or process in which password protection is desired (e.g., firmware updating, downloading or erasing date and entry or modifying the date and time).

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

In summary, one or more preferred embodiments of the present invention includes features recited in the above recitation of objects of preferred forms of the present invention. Further, those skilled in the art will readily realize other features described herein are novel and unobvious. Accordingly, the presented claims are not to be construed as the only inventive features of the subject patent application. Rather, the scope of the invention disclosed herein is only to be limited by the prior art, i.e., any subject matter disclosed herein that has not been claimed is not to be construed as lacking invention (i.e., novel and unobvious).

### BRIEF DESCRIPTION OF THE DRAWINGS

FIG. 1 is a perspective view illustrating a prior art handheld filter scanning probe.

FIG. 2 is a fragmentary cross-sectional view of the prior art probe illustrated in FIG. 1.

FIG. 3 is a perspective view illustrating the opposing side of the prior art probe depicted in FIG. 1.

FIG. 4 is a fragmentary perspective view of a portion of the prior art probe depicted in FIG. 1.

FIG. 4A is a fragmentary perspective view of a portion of a preferred form of a handheld filter scanning probe of the present invention.

FIG. 5 is a front view of a conventional connector for connecting a handheld filter scanning probe to a conventional base unit.

FIG. 6 is a perspective view of a prior art base unit with a portion of the housing of the base unit removed.

FIG. 7 is a perspective view of another preferred form of handheld filter scanning probe.

FIG. 8 is a partially exploded perspective view of the handheld probe depicted in FIG. 7.

FIG. 9 is a partially exploded perspective view of internal portions of the handheld probe of FIG. 7.

FIG. 10 is a perspective view of internal portions of the handheld probe of FIG. 7.

FIG. 11 is a perspective view of a portion of the probe depicted in FIG. 7 with internal portions shown as being removed from but next to a body portion of the handheld probe.

FIG. 12 depicts the preferred interactive screens or graphical user interfaces which are or can be displayed on the display of the handheld probes depicted in FIGS. 4a and 7 when the 100% response level of a corresponding base unit is set or determined by measuring upstream concentration.

FIG. 13 depicts the preferred interactive screens or graphical user interfaces which are or can be displayed on the display of the handheld probes depicted in FIGS. 4a and 7 when the 100% response level of a corresponding base unit is manually set by the user.

FIG. 14 depicts the preferred interactive screen or graphical user interface which is or can be displayed on the display of the handheld probes depicted in FIGS. 4a and 7 when the 100% response level of a corresponding base unit is manually set to a previous 100% response level.

FIG. 15 depicts a preferred interactive alarm setting screen or graphical user interface which is or can be displayed on the display of the handheld probes depicted in FIGS. 4a and 8 when a user activates the “Alarm” virtual icon to enable or disable any or all available alarms (i.e., audible, vibratory and/or visual).

FIG. 16 depicts the preferred interactive initial screen or graphical user interface which is or can be displayed on the display of the handheld probes depicted in FIGS. 4a and 7 with the “Set Internal Reference” being selected using a corresponding directional arrow. In this figure, both the down and up directional arrows of the possible directional arrows that can be displayed (i.e., up directional arrow, down directional arrow, left directional arrow and right directional arrow) are displayed as the up and down directional arrows are both operable due to selection of the “Set Internal Reference”.

FIG. 17 depicts the preferred interactive information entry screen or graphical user interface which is or can be displayed on the display of the handheld probes depicted in FIGS. 4a and 7 when the “Pad and Pencil” virtual icon is activated on any screen (e.g., initial screen) having the “Pad and Pencil” virtual icon.

FIG. 18 depicts the preferred interactive information entry screen or graphical user interface which is or can be displayed on the display of the handheld probes depicted in FIGS. 4a and 7 with a virtual information entry keyboard displayed on a lower portion of the screen due to a user touching the box appearing directly below “Job ID: ”.

FIG. 19 depicts a preferred interactive home screen or graphical user interface that is or can be displayed on the display of the handheld probes depicted in FIGS. 4a and 7 when the “House” virtual icon is activated on any screen having the “House” virtual icon. In this figure, only the down directional arrow of the possible directional arrows that can be displayed (i.e., up directional arrow, down directional arrow, left directional arrow and right directional arrow) is displayed as it is the only directional arrow that is operable (i.e., that can perform a function associated with the down direction arrow) on this screen due to the selection box surrounding the “Set 100% to Upstream Concentration.”

FIG. 20 depicts the preferred interactive screen or graphical user interface which is or can be displayed on the display of the handheld probes depicted in FIGS. 4a and 7 when a user activates the “Folder” virtual icon.

FIG. 21 depicts the preferred interactive screen or graphical user interface which is or can be displayed on the display of the handheld probes depicted in FIGS. 4a and 7 to allow a user to start a filter scan.

FIG. 22 depicts the preferred interactive screen or graphical user which is or can be displayed on the display of the handheld probes depicted in FIGS. 4a and 7 during a filter scan when data is being recorded.

FIG. 23 depicts the preferred interactive screens or graphical user interfaces which are or can be displayed on the display of the handheld probes depicted in FIGS. 4a and 7 during a filter scan to pause a filter scan and subsequently restart the filter scan.

FIG. 24 depict the preferred interactive screen or graphical user interface which is or can be displayed on the display of the handheld probes depicted in FIGS. 4a and 7 to activate the trim or rewind feature of a preferred form of the present invention.

FIG. 25 depicts a portion of the interactive screen or graphical user interface with a pop-window that is automatically displayed upon activation of the trim or rewind feature.

FIGS. 26 and 27 depict flow charts explaining the trim or rewind feature of a preferred form of the present invention.

FIG. 28 depicts the preferred interactive screens or graphical user interfaces which are or can be displayed on the display of the handheld probes depicted in FIGS. 4a and 7 to allow a user to complete a filter scan and enter any comments on the completed filter scan.

FIG. 29 depict the preferred interactive screens or graphical user interfaces which are or can be displayed on the display of the handheld probes depicted in FIGS. 4a and 7 allowing the user to activate the “Admin” virtual icon and subsequently to set or update security settings of the filter system.

FIG. 30 depicts the preferred interactive screen or graphical user interface which is or can be displayed on the display of the handheld probes depicted in FIGS. 4a and 7 when a user activates the “Folder” virtual icon and no external storage is connected to the handheld probe at the time of activation of the “Folder” virtual icon.

### DETAILED DESCRIPTION OF THE PREFERRED EMBODIMENT OF THE INVENTION

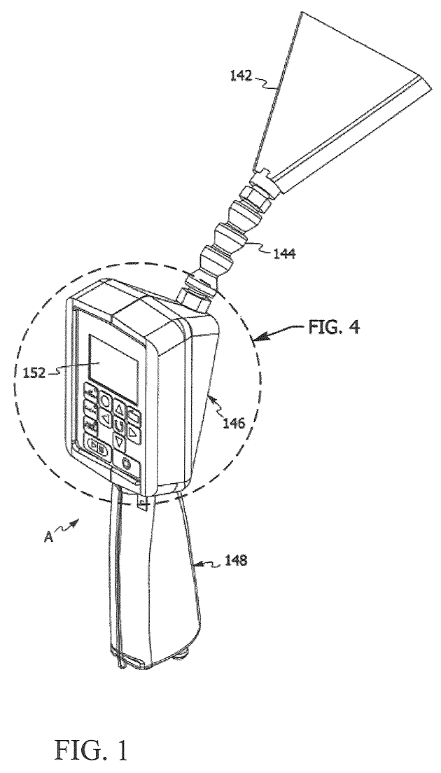

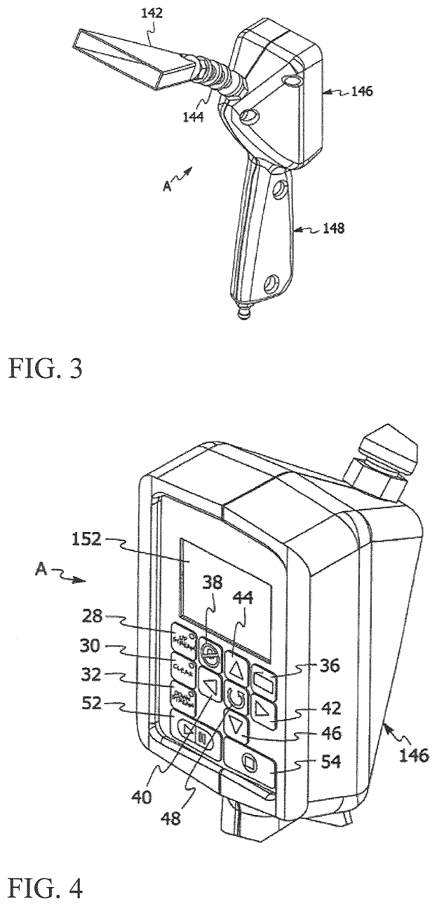

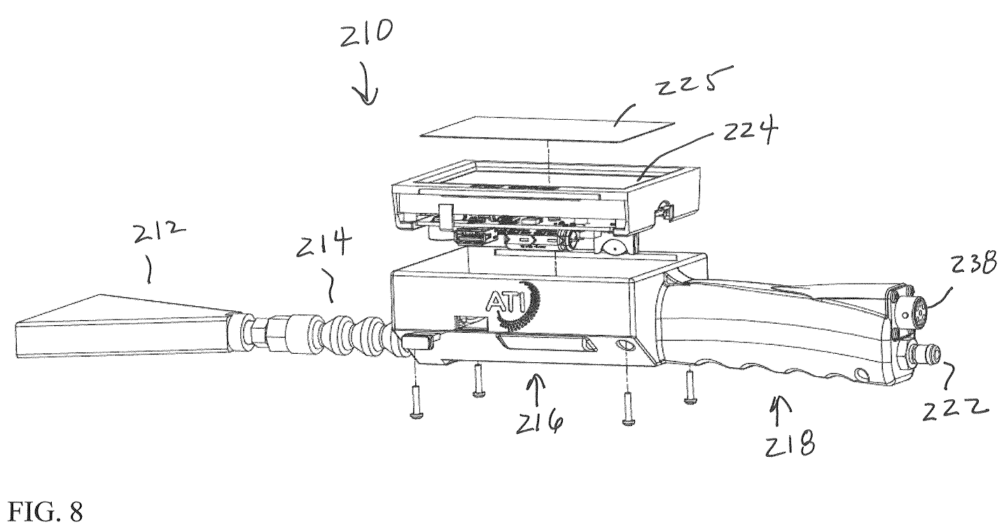

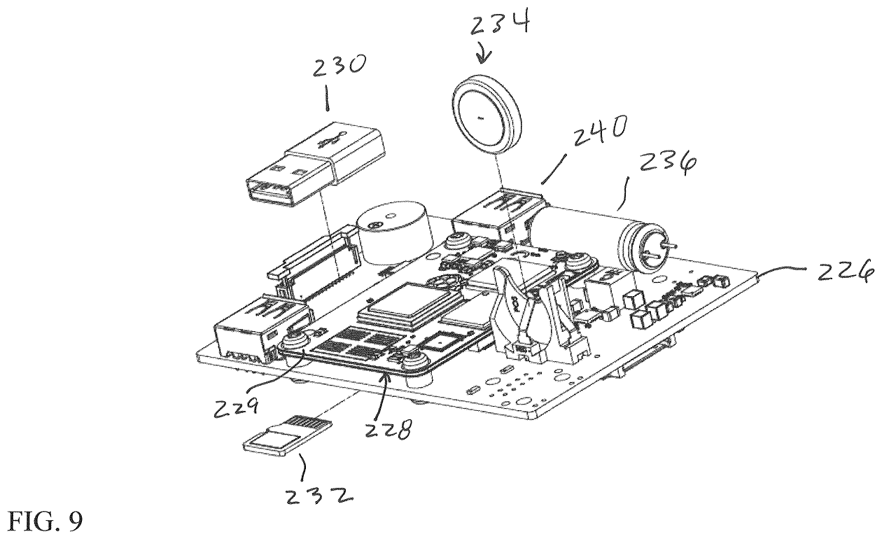

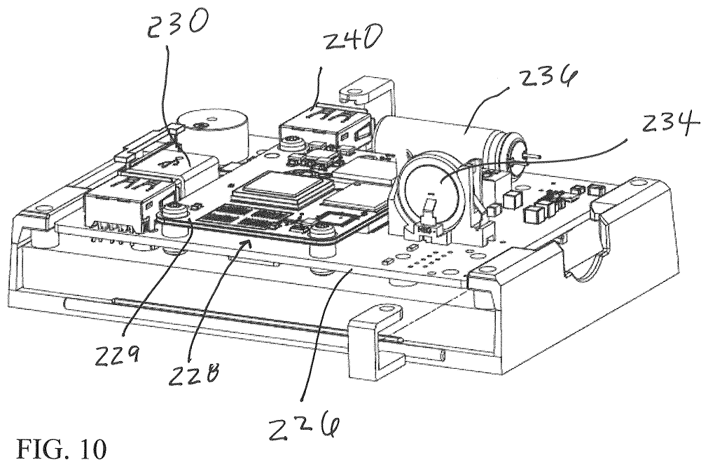

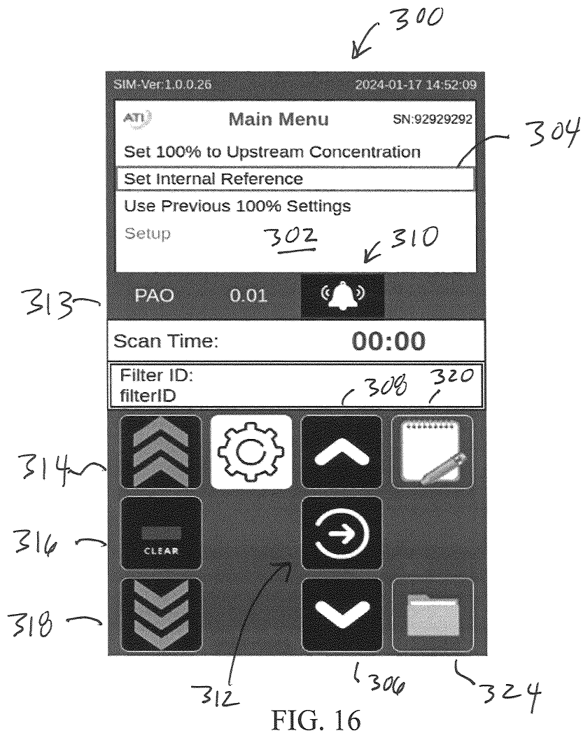

The most preferred forms of the invention will now be described with reference to FIGS. 1 to 30. The appended claims are not limited to the most preferred embodiments and no term used herein is to be given a meaning other than its ordinary meaning unless expressly stated otherwise.

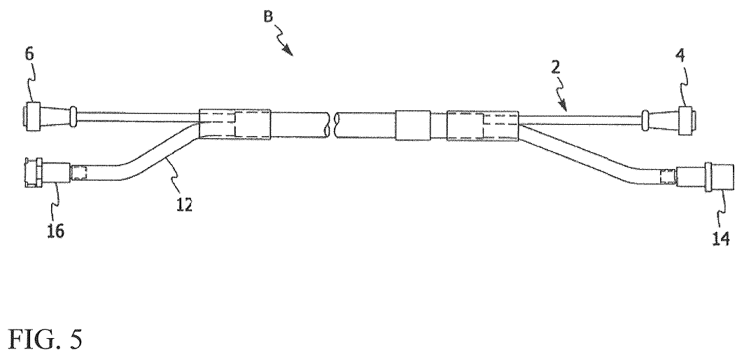

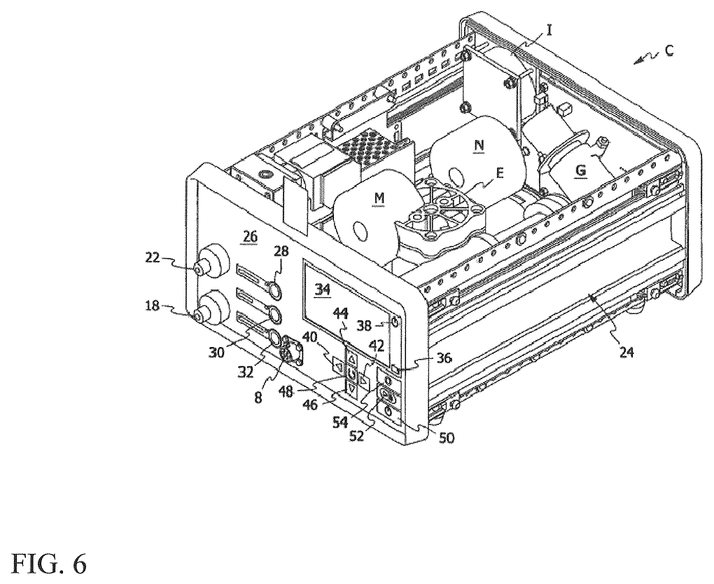

FIGS. 1 to 4, 5 and 6 depict components of the filter testing system disclosed in U.S. Pat. No. 9,772,271. The entire contents of U.S. Pat. No. 9,772,271 are incorporated herein by reference. FIGS. 1 to 4 illustrate the handheld probe A disclosed in U.S. Pat. No. 9,772,271. FIG. 6 illustrates the base unit disclosed in U.S. Pat. No. 9,772,271. FIG. 5 illustrates a connector for connecting the handheld probe to the base unit disclosed in U.S. Pat. No. 9,772,271.

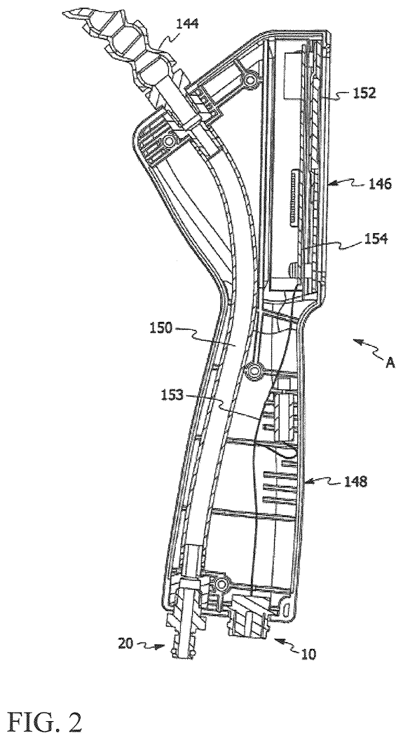

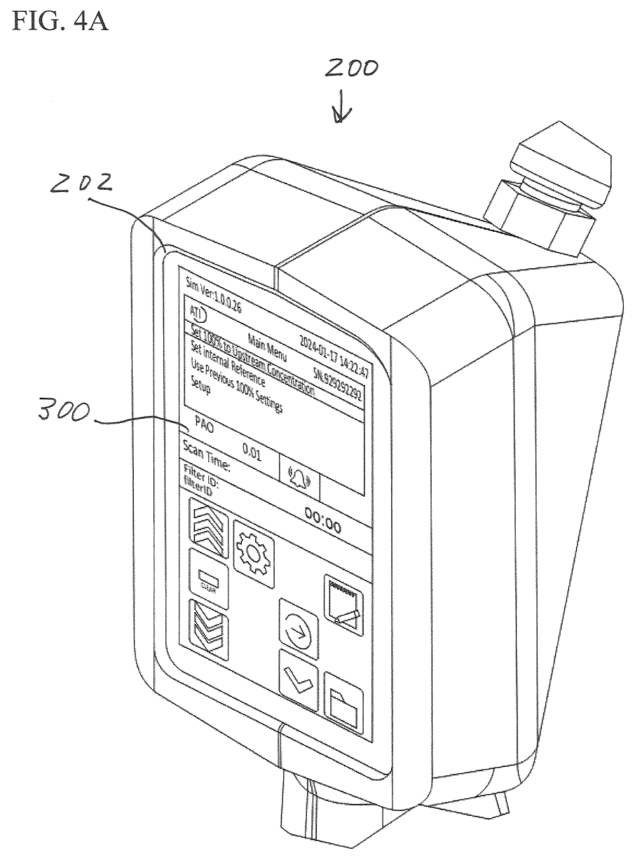

Referring to FIGS. 1 to 4, handheld probe A includes a test sample collection nozzle or head 142, a hollow, adjustable arm 144, a main body 146 and a handle 148. Arm 144 is in fluid tight communication with nozzle or head 142 and allows an operator to adjust the position of head 142. A conduit 150 (see FIG. 2) connects arm 144 to downstream test sample port 20 extending from the bottom of handle 148. Main body 146 includes a display screen 152, a circuit board 154 having a microprocessor and a plurality of control members. An electrical connector 153 connects the circuit board 154 to electrical connection port 10 extending from the bottom of handle 148. As seen in FIGS. 2 and 5, electrical connectors 2 and 153 connect circuit board 154 to main circuit board in base unit C. Probe A has many of the same control members as the base unit C (see FIG. 6). The same reference numerals have been used to designate the same control members for base unit C and handheld probe A. Referring to FIG. 4, main body 146 includes control members 28, 30, 32, 36, 38, 40, 42, 44, 46, 48, 52 and 54 the functions of each of these control members is explained in U.S. Pat. No. 9,772,271.

Referring to FIG. 6, base unit C includes a housing 24 having a frame 25, a front panel 26, a rear panel, a bottom panel and a cover panel (not shown). The cover panel preferably includes a handle. Housing 24 houses a manifold and valve assembly, dual headed vacuum pump E, a vacuum pump power supply, photometer G, a flow meter assembly, fan I, a power entry module, an interface board, a main circuit board L having a microprocessor, clean air filter M and exhaust air filter N.

Referring to FIG. 6, electrical connection port 8, downstream test sample port 18 and upstream test sample port 22, extend outwardly from front panel 26. Front panel 26 preferably includes three control members 28, 30 and 32. Base unit C will test an upstream sample when control member 28 is activated by an operator depressing this control member. Base unit C will test a downstream test sample when control member 32 is activated by an operator depressing this control member. When control member 30 is depressed by an operator, residual test samples in the base unit C will be exhausted from the filter testing system.

Front panel 26 further includes an LCD display screen 34 for displaying the operating menu of the filter testing system as well as the results of the filter test. Front panel 26 also includes control members 36 and 38. Upon depression of control member 36, an alpha-numeric keyboard or pad will be displayed on screen 34. Control member 38 allows an operator to disable the audible alarm feature of the filter test system if desired, i.e., by depressing control member 38 the audible alarm that would typically sound when a filter has failed the test will be disabled. Front panel 26 includes cursor directional control members 40, 42, 44 and 46 which allow an operator to move a cursor left, right, up and down on screen 34, respectively. Control member 48 is also provided on front panel 26. Control member 48 acts as an enter key. Using control members 40 through 48, an operator may readily navigate through the alpha-numeric keyboard and the menu to enter information regarding a filter being tested or select various features available in the menu. Front panel 26 further includes control members 50, 52 and 54. Upon depression of control member 50 the base unit will power up. By pressing the arrow portion of control member 52, the filter testing system will perform the test selected by the operator. By pressing the two parallel vertical lines portion of control member 52, the test being performed will be paused. To continue the filter test, the arrow portion of control member is depressed. By depressing control member 54, the test is stopped. The operation of the base unit C and the components thereof including those discussed briefly above is explained in U.S. Pat. No. 9,772,271.

As seen in FIG. 5, coupling assembly B includes an electrical coupler 2 having electrical connectors 4 and 6 disposed at opposite ends. When probe A is to be used with the base unit C to test a filter, connector 4 is coupled to electrical connection port 8 (see FIG. 6) of base unit C and connector 6 is coupled to electrical connection port 10 (see FIG. 2) of probe A. Coupling assembly C further includes a fluid conduit 12 having connectors or couplers 14 and 16 disposed at opposite ends. Connector 14 is coupled to downstream test sample port 18 (see FIG. 6) of base unit C while connector 16 is coupled to downstream test sample port 20 (see FIG. 2) of probe A. A conduit (not shown) similar to fluid conduit 12 may be used to convey a test sample (preferably aerosol) upstream of the filter being tested into the base unit C through upstream test sample port 22 for testing of the upstream test sample.

FIG. 4A illustrates a handheld probe 200 of a preferred embodiment of the present invention in which all physical control members 28, 30, 32, 36, 38, 40, 42, 44, 46, 48, 52 and 54 of probe A have been removed. The display screen, area or section 202 has been significantly enlarged from the display screen, area or section 152 of the handheld probe A disclosed in U.S. Pat. No. 9,772,271. For example, display 202 of handheld probe 200 encompasses, inter alia, the area previously occupied by the physical control members 28, 30, 32, 36, 38, 40, 42, 44, 46, 48, 52 and 54 of the handheld probe A. In a most preferred embodiment, handheld probe 200 is configured to be used with base unit C disclosed in U.S. Pat. No. 9,772,271 without any modification of the base unit C.

Because of the nature of the communications between probe 200 and base unit C, the activation of arrow keys 40, 42, 44 and 46 and enter button 48 of base unit C is mirrored by probe 200. For example, items that are selectable in the top half of the various graphical user interfaces displayed on the display screen 202 are accessed via the virtual arrow keys and virtual enter button presented on screen 202 of probe 200. However, the mirroring can be “masked” in those instances where only one choice is selectable. Items in the bottom half of various graphical user interfaces displayed on the display screen 202 preferably act as a typical touchscreen, as they represent either physical buttons on probe A which can be pressed at any time or buttons that are new to probe 200.

The same coupling assembly B or a similar coupling assembly can be used to connect probe 200 to base unit C.

A preferred embodiment of the present invention includes a base unit in which all physical control members of base unit C are replaced with virtual activation icons activated by touching a corresponding portion of the graphical user interface displayed on display screen 34. In another preferred embodiment, all physical control members of the base unit C are replaced with virtual activation icons with the sole exception of a physical “on/off” button or control member (e.g., power button 50 depicted in FIG. 6).

In those instance where probe 200 is used with a new (i.e., a base unit specifically configured for probe 200) rather than an existing base unit (e.g., base unit C), any interactive portion of the various graphical user interfaces displayed on the display screen 202 can be activated merely by touching a corresponding portion of the displayed graphical user interface.

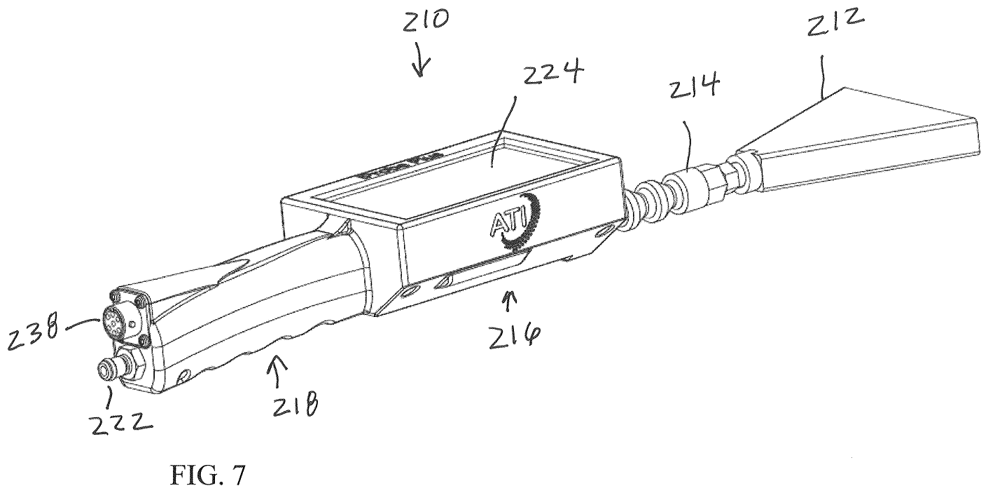

Referring to FIGS. 7 to 11, another preferred form of handheld probe 210 will now be described. Probe 210 as described below is configured to be connected to base unit C without altering base unit C. Accordingly, the above discussion of mirroring aspects of probe 200 to base unit C is applicable to probe 210. Like probe 200, probe 210 can be used with a new rather than an existing base unit and as such can be configured so that any interactive portion of the various graphical user interfaces displayed on the display screen of probe 210 can be activated merely by touching a corresponding portion of the displayed graphical user interface.

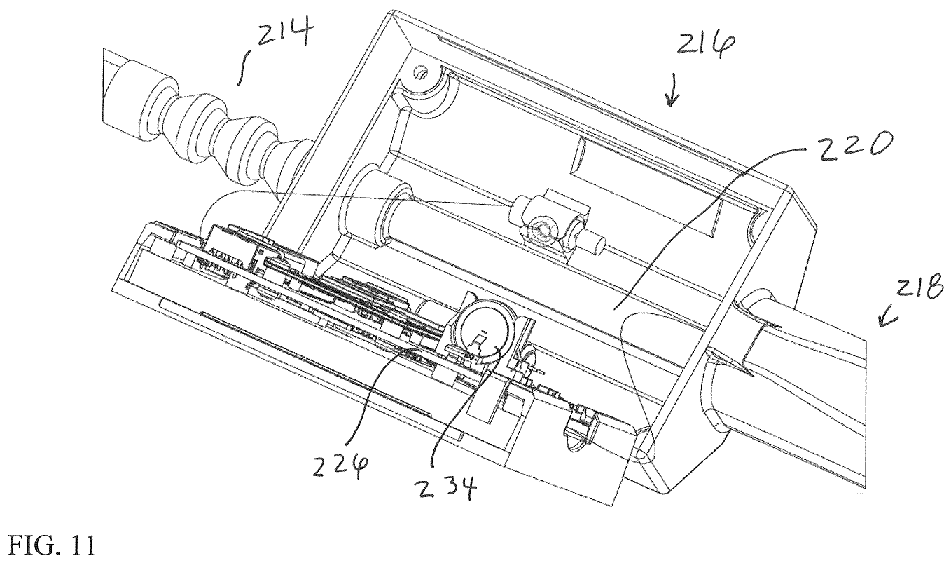

Handheld probe 210 includes a test sample collection nozzle or head 212, a hollow, adjustable arm 214, a main body 216 and a handle 218. Arm 214 is in fluid tight communication with nozzle or head 212 and allows an operator to adjust the position of head 212. A conduit 220 (see FIG. 11) connects arm 214 to downstream test sample port 222 extending from the bottom of handle 218.

Main body 216 includes a display screen 224, a transparent display screen protective layer 225, a circuit board 226, a computer 228 including a microprocessor 229 (e.g., Raspberry Pi processor), an internal USB 230, a mini or micro SD card 232, a battery 234 and a super capacitor 236. One or more electrical connectors of any suitable type connect the circuit board 226 to electrical connection port 238 extending from the bottom of handle 218. Electrical connector 2 of coupling assembly B may be used to electrically connect probe 210 to the main circuit board in base unit C. However, any probe 210 may be electrically connected to the base unit C using any suitable connector or connectors. Socket 240 is provided to connect an external USB stick or drive (not shown) to circuit board 226 to, for example, download scan data.

The internal USB 230 can store computer software code, scan data and other data associated with a filter test or scan. The mini SD card 232 can store computer code and one or more operating systems (e.g., Linux operating system). Computer 228 runs the operating system or systems including the touch screen program. Battery 234 powers the real time clock of the handheld probe 210. Super capacitor 236 holds charge to keep the computer running for a predetermined time (e.g., 20 seconds) after the base unit has been disconnected from a power source (e.g., power outlet). While a super capacitor is described as a preferred means to keep the computer running, any other suitable device could be used (e.g., a battery). Furthermore, the handheld probe need not include any means including, but not limited to, the super capacitor to keep the computer running after the base unit has been disconnected.

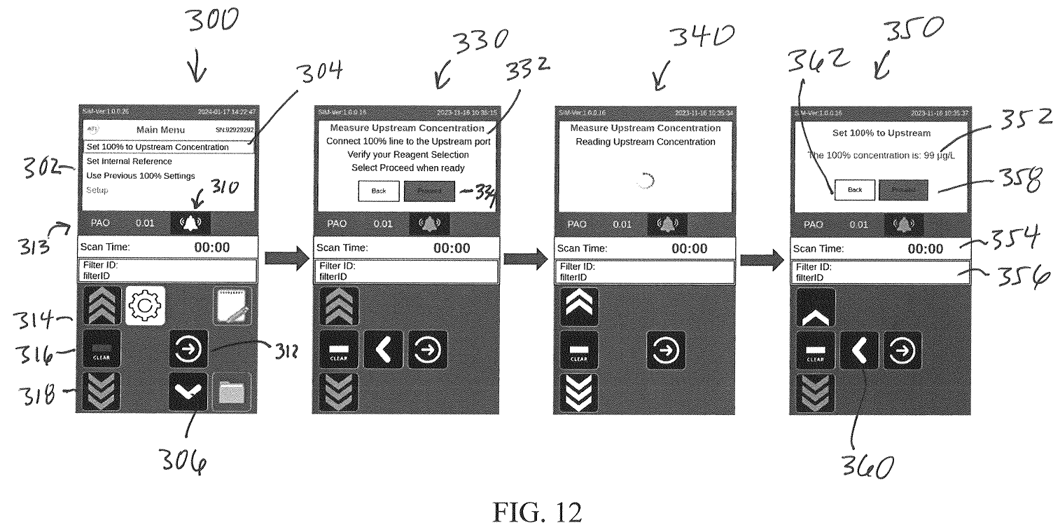

Referring to FIGS. 12 to 30, a preferred operation of the filter system formed in accordance with the present invention will be described. Once the base unit is connected to a power source (e.g., plugging in base unit C to a power outlet) and the handheld probe (either probe 200 or probe 210) is connected to the base unit using coupling assembly B or a similar coupling assembly, an initial or start interactive screen 300 will be displayed on the display of the handheld probe. This is seen in FIG. 4A depicting screen 300 populating display 202 of probe 200. Start or initial interactive screen 300 is also shown in FIGS. 12 to 14 and 16. All other interactive screens or graphical user interfaces will or can be displayed on the display of the handheld probe. While the interactive screens or graphical user interfaces described below allow the user to perform numerous functions from a given user interface, any or all of the user interfaces described below can be simplified where desired.

Start screen 300 includes an upper section 302 from which a user can select one of three ways to designate the value of the upstream aerosol concentration that represents the 100% Concentration of the upstream aerosol. The three ways are: (i) measuring the upstream concentration (“Set 100% to Upstream Concentration” item of screen 300); (ii) manually setting the 100% Concentration (“Set Internal Reference” item of screen 300); and, (iii) using a previously set value for the 100% Concentration (“Use Previous 100% Settings” item of screen 300). Interactive directional arrow icons allow the user to select one of the three different ways to designate the value of the upstream aerosol concentration that represents the 100% Concentration of the upstream aerosol. As is seen in FIG. 12, the first of the three ways has been selected, i.e., “Set 100% to Upstream Concentration” as it is surrounded by box 304. Start screen 300, in FIG. 12, only includes a downward directional arrow interactive icon 306 as selecting box 304 can only be moved downward in area 302 due to box 304 surrounding “Set 100% to Upstream Concentration” in FIG. 12. Displaying only the directional arrow or arrows interactive icons that can be activated by a user reduces the likelihood that a user attempts to activate an icon having a function which serves no purpose or cannot be performed on a particular interactive screen or graphical user interface.

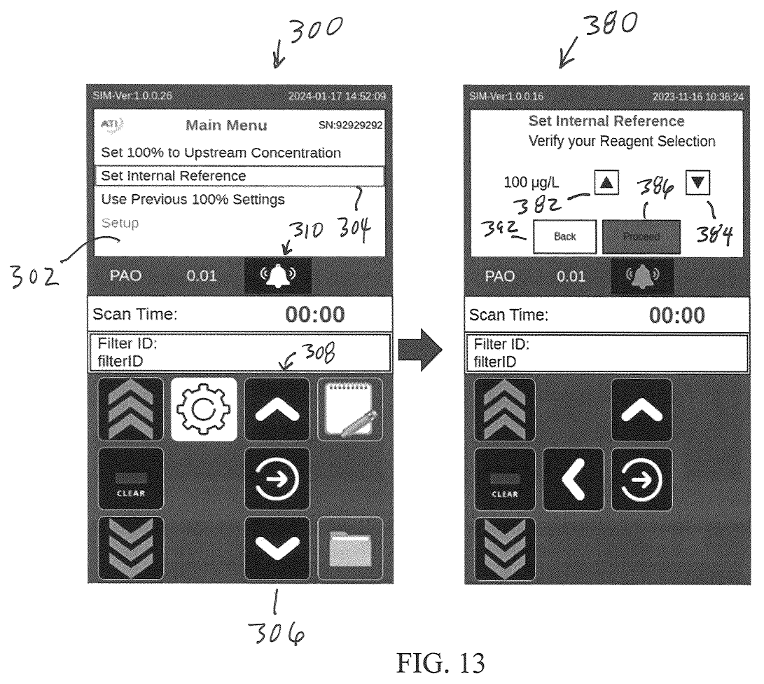

In FIG. 13, the second way (i.e., “Set Internal Reference”) has been selected and both upward directional arrow interactive icon 308 and downward arrow interactive icon 306 appear on screen 300 as the user can move upwardly or downwardly box 304 to change the way or manner of designating the value of the upstream aerosol concentration that represents the 100% Concentration of the upstream aerosol. “Setup” in section 302 is greyed out as it cannot be activated but needs to appear in section 302 to mirror base unit C.

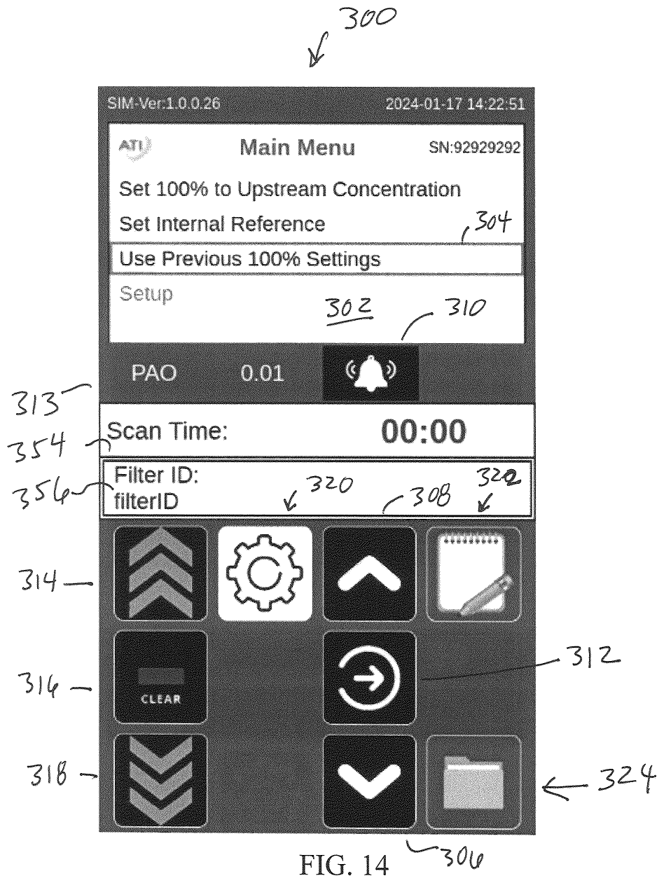

Icon 306 also allows the user to select and activate alarm setting icon 310 the function of which will be explained below. For example, in screen 300 as depicted in FIG. 14, the user touches icon 306 twice to highlight icon 310 which can be activated by touching or tapping on enter icon 312 once icon 310 is highlighted.

The horizontally extending section 313 of screen 300 identifies the reagent (e.g., PAO) and alarm set point (e.g., 0.01) along with alarm setting icon 310. The reagent and alarm set point are not active on screen 300. Screen 300 also includes upstream graphical representation 314, clear mode graphical representation 316 and downstream graphical representation 318 none of which are active on screen 300. Clear mode graphical representation 316 can be animated to inform the user that base unit C is the clear mode when screen 300 is displayed. For example, the animation could take the form of greying out elements 314 and 318 without greying out element 316. Any other manner of animation may be used to inform the user that the base unit C is in the clear mode when screen 300 is displayed.

Screen 300 further includes Admin interactive icon 320, pad and pencil interactive icon 322 and file folder interactive icon 324 each of which can be activated by merely touching the icon that the user wants to activate.

Touching icon 312 when box 304 appears around the first option (“Set 100% to Upstream Concentration”) will cause screen 330 (see FIG. 12) to populate the display of the handheld probe. Screen 330 can include a message 332 to the user to connect a 100% line directly to upstream port 22 of base unit C. When screen 330 is initially displayed to the user the

“Procced” box 334 is highlighted. If icon 312 is activated by touching or tapping on icon 312 when the “Procced” box 334 is highlighted, screen 340 will populate the display of the handheld probe indicating that the upstream concentration is being read/measured. Once the upstream concentration has been determined, screen 350 will populate the display of the handheld probe. Screen 350 can include a message 352 (e.g., “The 100% concentration is: 99 μg/L informing the user of the 100% concentration (e.g., 99 μg/L).

As seen in FIG. 12, screens 300, 330, 340 and 350 all include a filter scan time section 354 and a filter ID section 356. The filter scan section 354 identifies the current time period of the filter scan. As the filter scan has not started, the Scan Time appears as “00:00”. The filter ID section 356 identifies the filter being scanned by, for example, a unique filter identification designation.

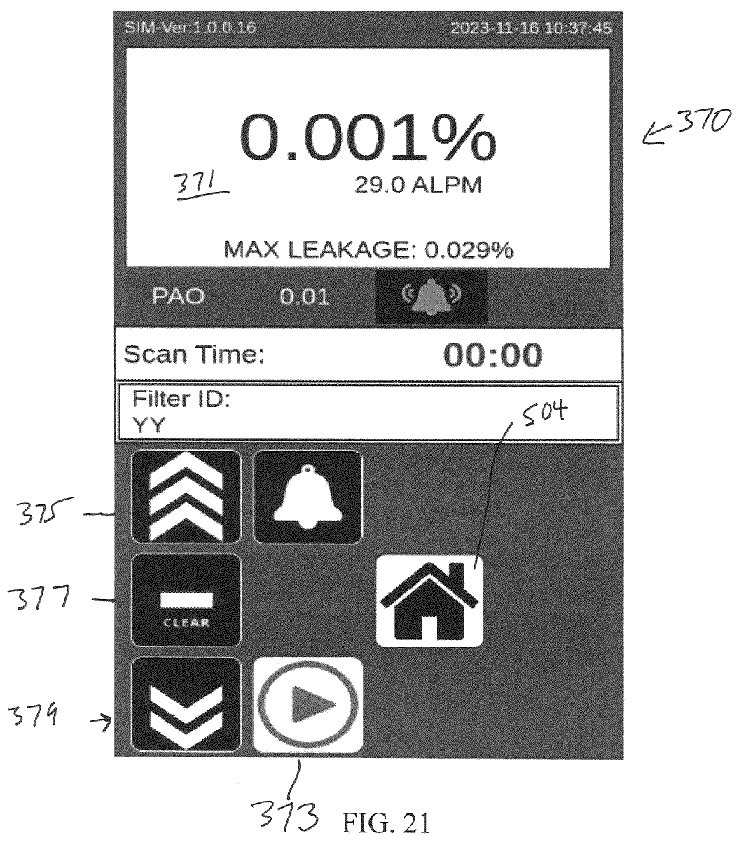

When screen 350 is initially presented to the user, the “Proceed” box 358 is highlighted so that a user can perform the function associated with this box by touching icon 312. When the “Proceed” box 358 is highlighted and the user touches icon 312, stand by screen 370 (see FIG. 21) populates the display of the handheld probe.

Screen 350 also includes only the left directional arrow interactive icon 360 which when activated highlights the “Back” box 362 as this is the only type of directional arrow that can perform a function on screen 350. When the “Back” box 362 is highlighted and the user touches icon 312, screen 300 will populate the display of the handheld probe if screen 350 was reached by a user interacting with screen 300.

Referring to FIG. 13, when selection box 304 is around the second option (i.e., “Set Internal Reference”) in section 302 of screen 300 and the user touches icon 312, screen 380 (see FIG. 13) will populate the display of the handheld probe. Screen 380 includes interactive adjustment members 382 and 384 that allow a user to adjust the 100 μg/L 100% concentration upwardly (icon 382) or downwardly (icon 384) to set the 100% concentration desired by the user by touching either icon 382 and/or icon 384. Once adjusted to the desired 100% concentration and with the “Proceed” box 386 highlighted as shown in FIG. 13 the user can touch icon 312 and the selected reference value is communicated to the base unit, which makes the necessary adjustments and then the continuous reading on a given interactive screen will reflect those selected settings. Directional arrow icons can be provided on screen 380 to allow the user to move around in the Set Internal Reference box of screen 380. Left directional arrow icon 360 once touched by the user, will move from the highlighted “Proceed” box 386 in FIG. 13 to highlight the “Back” box 392 on screen 380. When the “Back” box 392 is highlighted and the user touches icon 312, screen 300 will populate the display of the handheld probe. Only left and up directional arrow icons appear on screen 380 when the “Proceed” box 386 is highlighted as these are the only directional arrows that can perform a function when screen 380 is as depicted in FIG. 13.

Referring to FIG. 14, when box 304 is around the third option (i.e., “User Previous 100% Settings”) in section 302 of screen 300 and the user touches or taps on icon 312, the 100% concentration is set at the previous 100% concentration setting and stand by screen 370 (see FIG. 21) populates the display of the handheld probe.

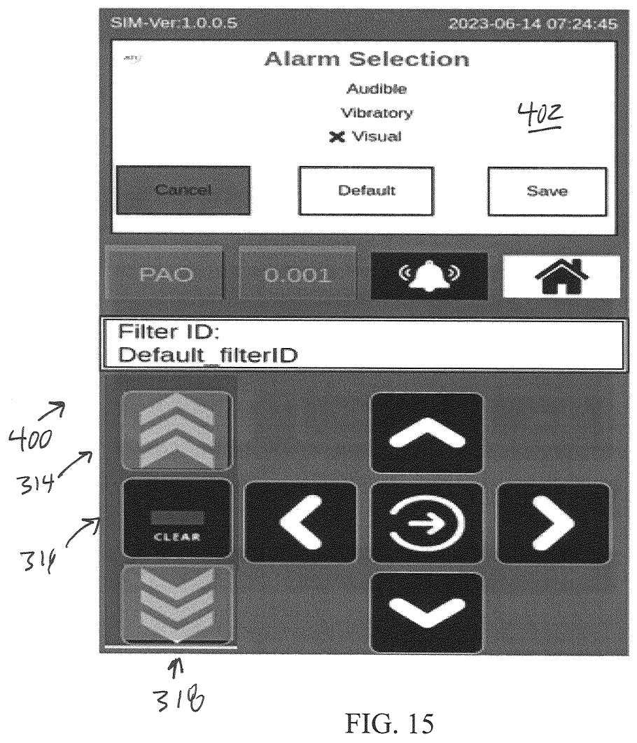

Referring to FIGS. 12, 13 and 15, when alarm icon 310 of screen 300 is highlighted by user manipulation of one or more directional arrows and the user touches icon 312, screen 400 populates the display of the handheld probe. As seen in FIG. 15, directional arrow interactive icons are displayed in the lower portion of screen 400 to allow the user to move around in the alarm selection box 402 to set or change the alarm settings for the audible alarm, vibratory alarm and the visual alarm by highlighting individual one or more of the audible alarm, vibratory alarm and the visual alarm and touching icon 312. Also, “Cancel” “Default” and “Save” boxes in the alarm selection box 402 can be highlighted by using a corresponding directional arrow icon. Touching icon 312 when the “Cancel” box is highlighted will return to the previously displayed screen with no changes to the alarm settings. Touching icon 312 when the “Default” box is highlighted will return to the prior displayed screen with the three alarm settings (i.e., the audible alarm, vibratory alarm and the visual alarm) set to the default setting for each of the three alarm settings. Touching icon 312 when the “Save” box is highlighted will return to the prior displayed screen with the alarm setting as modified by the user manipulating screen 400. For example, screen 400 has only the visual alarm activated as indicated by the “X” appearing to the left of the visual alarm line in box 402. Highlighting the “Save” box using the right directional arrow interactive icon and touching icon 312 of screen 400 will adjust any prior alarm settings to only a visual alarm and the prior screen will populate the display of the handheld probe.

Screen 400 can include also includes upstream graphical representation 314, clear mode graphical representation 316 and downstream graphical representation 318 none of which are active on screen 400 with representations 314 and 318 greyed out while representation 316 is not greyed out to inform the user that base unit C is in clear mode when screen 400 populates the display of the handheld probe.

Once the 100% reference has been set using one of the three ways previously discussed in connection with FIGS. 12 to 14, the filter system is ready for measurements (i.e., filter scanning) and the downstream mode will be automatically selected but scanning is not yet started. At this juncture, the display of the handheld probe is populated with screen 370 (see FIG. 21). Measured concentration is displayed at all times during a filter scan in box 371, from whichever valve is selected. The maximum leakage detected during any given filter scan is also displayed in box 371 of screen 370. It is beneficial to the user to be able to easily see what the maximum leakage is for any given filter scan. The reason for this is that the user needs to note the maximum leakage value to their end customer by either writing it down or remembering it. Having the maximum leakage on the display will eliminate the need to write it down or remember it.

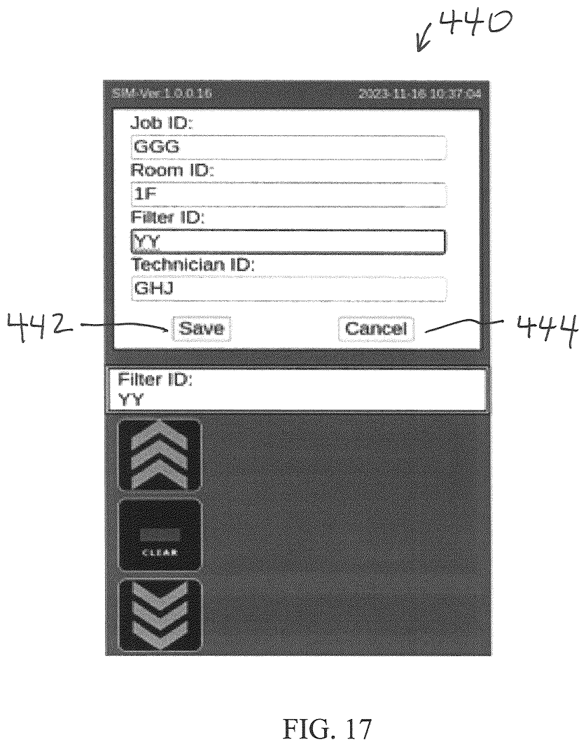

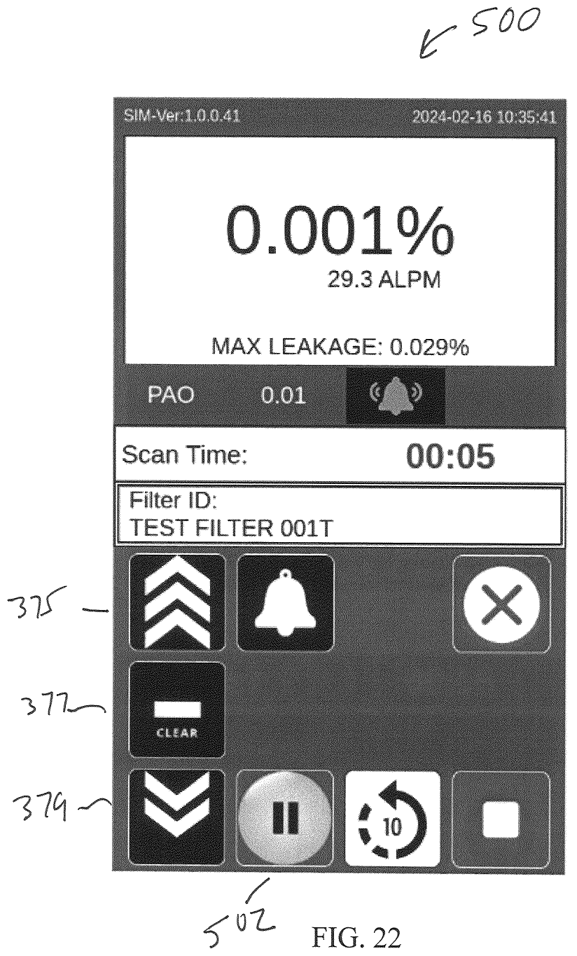

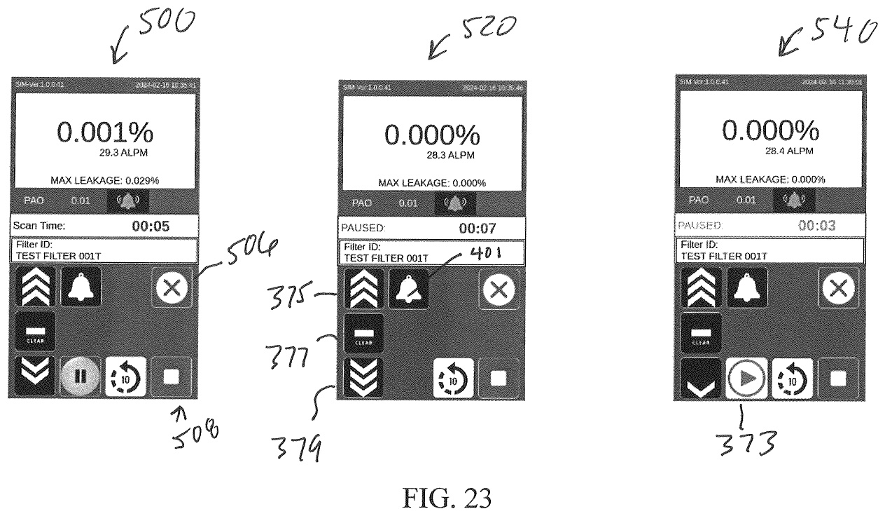

Once the user reaches screen 370, touching the start interactive icon 373 will automatically populate the display of the handheld probe with information entry screen 440 (see FIG. 17). All of the fields of screen 440 (i.e., Job ID field, Room ID field, Filter ID field and Technician ID field) are editable. The system can be configured so that one or more of the editable fields must contain a value before proceeding to scanning of any given filter. The user can save the information appearing in each of the editable fields by touching the “Save” box 442 the displayed values, cancel all information appearing in each of the editable fields by touching the “Cancel” box 444 or edit any of the editable fields by touching the corresponding box for a particular editable field. Touching “Save” box 442 will populate the display of the handheld probe with screen 500 (see FIGS. 22 and 23) provided that any required information in the editable fields is present and recording of filter scanning data will automatically commence.

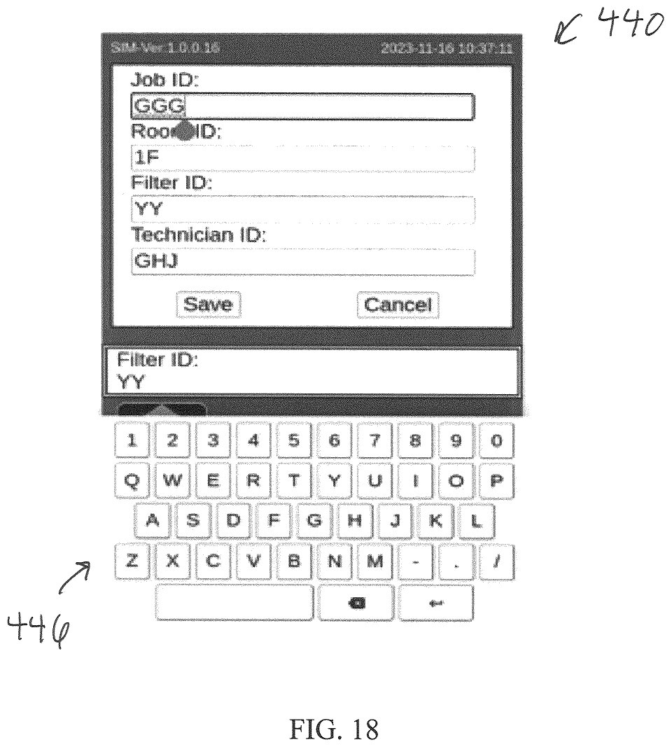

FIG. 18 shows how information in any of the editable fields may be edited or changed. In FIG. 18, the user has touched the box corresponding to the Job ID editable field causing the interactive edit keyboard 446 to be displayed over a lower portion of screen 440. The user merely touches the appropriate key or keys of the interactive edit keyboard 446 to edit the information appearing in the box corresponding to the Job ID editable field. The other editable fields can be edited in a similar manner.

Information entry screen 440 will also be displayed to the user when pad and pencil icon 322 on any screen having icon 322 is activated by the user (i.e., touched by the user) to allow the user to initially populate all editable fields or alter the information in any editable fields using virtual keyboard 446. When either the “Cancel” box or “Save” box are activated by the user, the user will be returned to the prior screen.

Scan recording can only take place when the filter system is in downstream mode. Downstream interactive icon 379 of screen 370 can be animated to inform the user that the filter system is in the downstream mode. If the user touches either the clear mode interactive icon 377 or the upstream interactive icon 375, start icon 373 will disappear ensuring that recording of filter scan data only occurs when the system is in the downstream mode. Touching downstream interactive icon 379 will cause the start icon to reappear.

Again, the recording of filter scanning data can only occur when the filter system is in the downstream mode. Accordingly, if either icons 375 or 377 appearing on screen 500 are activating by a user touching or tapping on the same, the current filter scan will be put into a pause mode. The filter scan can also be put into pause mode by a user touching interactive pause icon 502. If the pause mode has been activated by either method described above, the filter system stops collecting new data and the scan time is frozen to that time that the pause mode was entered, although the currently displayed screen continues to reflect the current readings as seen in screen 520 of FIG. 23. For example, if the pause mode is entered 7 seconds into the filter scan, the scan time is fixed at 7 seconds. As seen in FIG. 23, the “Scan Time:” can be replaced with “Paused:” to indicate to the user that the system is in pause mode. The “Paused:” portion of screen 520 and/or screen 540 can appear in red and flash to ensure that the user realizes that the system is in pause mode. In the pause mode, the system is placed in clear mode. In order to restart, the user must first place the system in downstream mode by touching icon 379 of screen 520, whereupon the start icon 373 reappears (see screen 540 of FIG. 23) and can be activated to resume the recording of filter scan data while also unfreezing the filter scan time so that the filter scan time continues to advance from the filter scan time at which the pause mode was entered.

Any time the interactive alarm toggle icon 401 appears on a screen, the user can touch this icon to toggle the alarm mode between silent and active. In silent, any and all of the alarm settings previously set are disabled. If the alarms are disabled an “X” will appear in the bell portion of icon 401 to inform the user that the auditory and vibratory alarms have been disabled with the visual alarm remaining enabled. To enable the muted to disable auditory and/or vibratory alarms, the user need only touch or tap on icon 401 again.

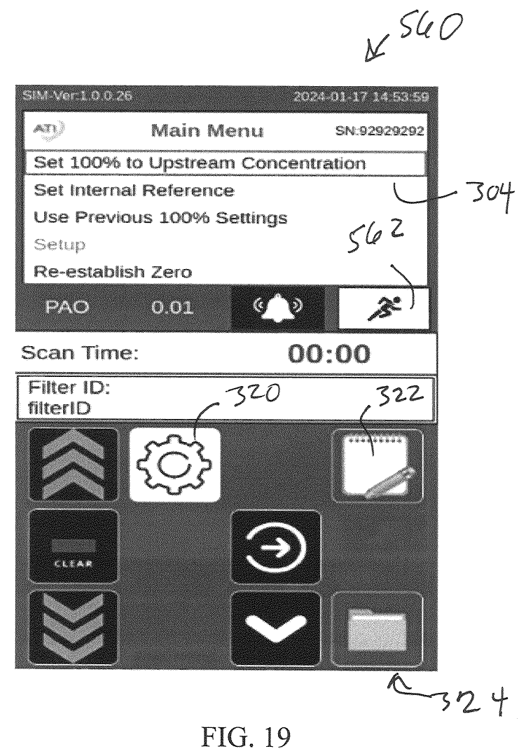

Any time the interactive house/home icon 504 appears on a screen (see, for example, FIG. 21), the user can touch this icon to populate the display of the handheld probe with screen 560 (see FIG. 19). Activation of the running man icon 562 on home screen 560 causes the display of the handheld probe to be populated with stand by screen 370.

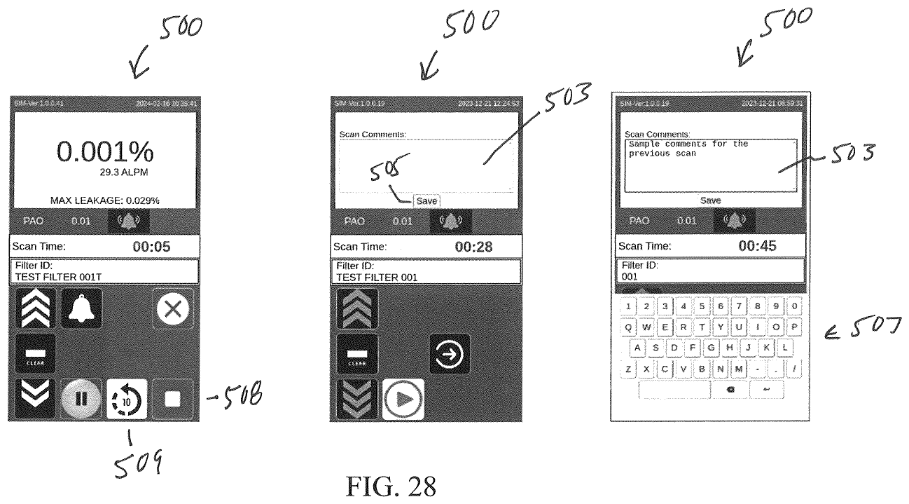

When discard icon 506 of screen 500 is activated (i.e., touched by a user) during a filter scan and subsequently confirmed by the user that activation of this icon was intended, the current filter scan will be discarded. When scan completion icon 508 of screen 500 is activated (i.e., touched by a user) during a filter scan, a pop-up window or interactive box 503 appears in the top box of screen 500 as shown in FIG. 28 and the pause, rewind, discard and complete scan icons all disappear and start icon appears in the exact same space as the removed pause icon. If the user touches or otherwise activates “Save” box 505 before entering any text in comments box 503, the system saves the record of the completed filter scan without adding any comments. If the user touches inside the comments box 501, a virtual keyboard 507 appears on the lower portion of screen 500 which can be used to enter any desired comments a user may have for the completed filter scan.

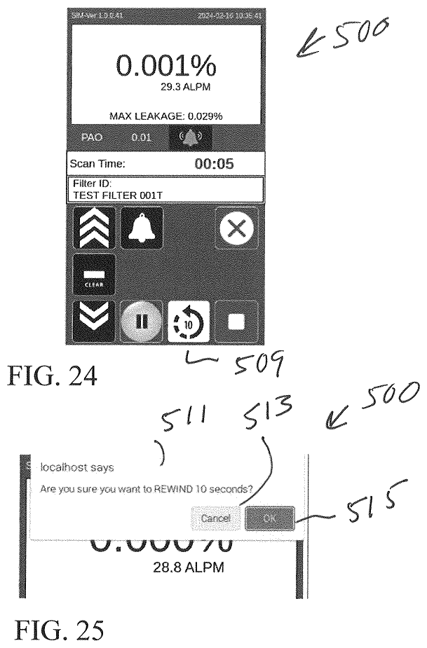

The process that ensues from a user touching or otherwise activating rewind/trim icon 509 on screen 500 during a filter scan will now be described with reference to FIGS. 24 to 27. Referring to FIGS. 24 and 25, if the user activates rewind/trim icon 509 on screen 500 during a filter scan, pop-up window 511 will appear on a portion of screen 500 (e.g., upper portion) asking the user to confirm that the rewind/trim function is to be performed.

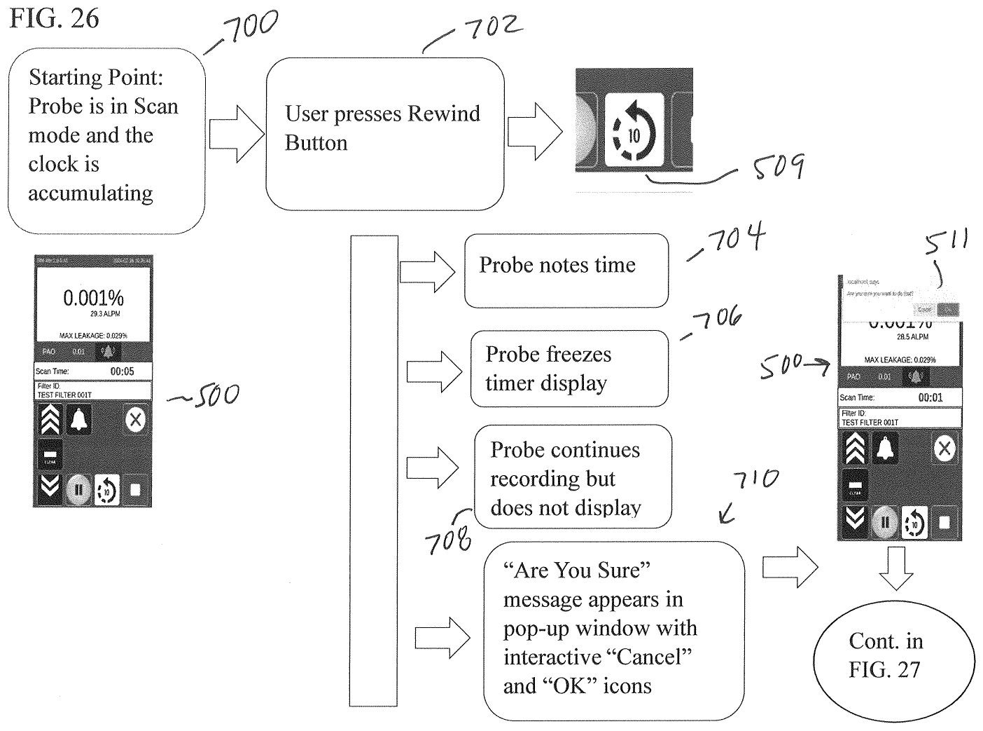

Referring to FIG. 26, starting point 700 is the initial starting point in which the system is in filter scan mode and the clock corresponding to the scan time is accumulating. In step 702, the user touches or other activates the rewind/trim icon 509. In step 704, the probe notes the time of activation of icon 509. In step 706, the probe freezes the scan time display to the elapsed scan time when icon 509 is activated, i.e., if icon 509 is activated at one minute and thirteen seconds of the filter scan, the probe freezes the scan time display to one minute and thirteen seconds. In step 708, the probe continues recording scan data but does not display the new data. In step 710, an “Are You Sure” message appears in pop-up window 511 with interactive “Cancel” and “OK” icons 513 and 515, respectively.

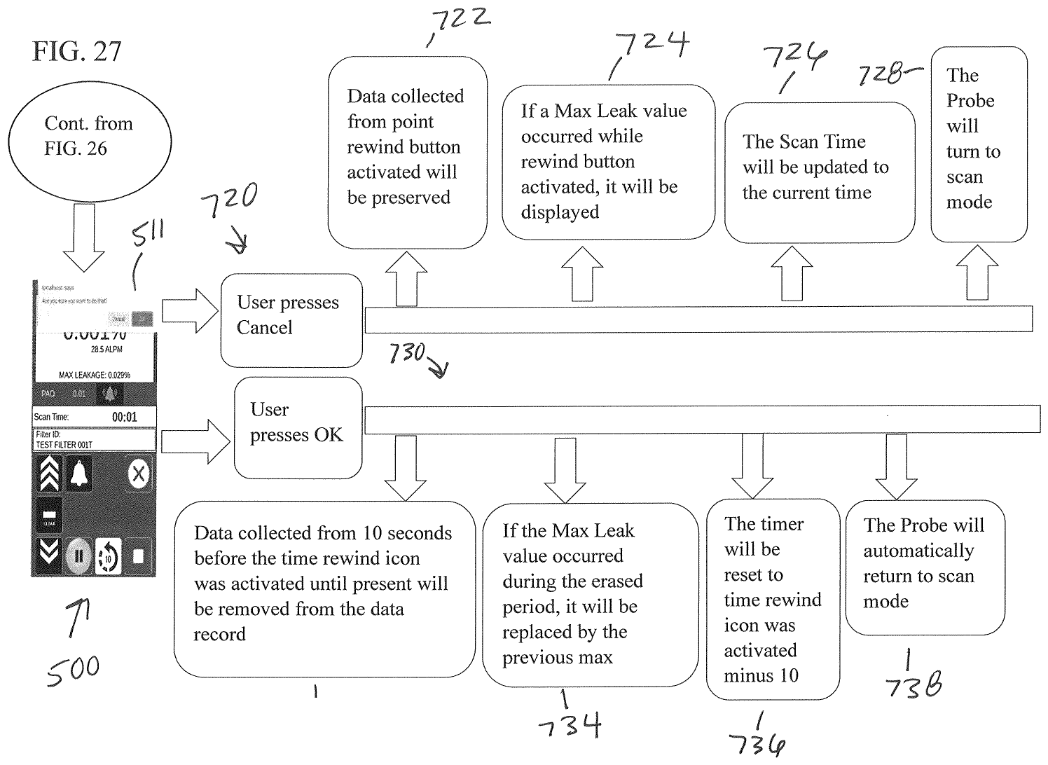

Referring to FIG. 27, branch 720 of the depicted flow chart explains the processes that occur when a user activates “Cancel” icon 513 in pop-up window 511. In step 722, data collected from point rewind button activated to the point icon 513 will be preserved. In step 724, if a maximum leakage value occurs while icon 509 is activated, the maximum leakage value will be displayed in box 501 of screen 500. In step 726, the scan time will be updated to the current time. In step 728, the probe will return to scan mode as if icon 509 was never activated and all scan data from the time icon 509 was activated to the current time will be preserved.

Branch 730 of the flow chart depicted in FIG. 27 explains the processes that occur when a user activates “OK” icon 515 in pop-up window 511. In step 732, data collected from 10 seconds immediately before the time rewind icon was activated until present time will be removed (i.e., erased) from the data record. In step 734, if a maximum filter leakage occurs during the erased period, it will be replaced with the previous detected maximum filter leakage. In step 736, the scan time will be reset to the time icon 509 was activated minus 10 seconds. In step 738, the probe will automatically return to the scan mode without any other user interaction with any portion of screen 500.

While a preferred rewind/trim period is 10 seconds, the rewind/trim period can be varied to be less than or more than 10 seconds. Further, the system can be configured to allow authorized users to adjust the rewind time period. Also, handheld probe A and/or base unit C could be modified to include a physical rewind/trim activation member. Further, the base unit could include a graphical user interface including a virtual rewind/trim activation member. Furthermore, the system could be configured such that upon activation of the rewind/trim icon the system detects a spike or other condition that is not indicative of a filter failure and rewind that portion of the scan to erase or delete the spike or other detected condition. Moreover, the system can be configured to include multiple different set of filter record scans. For example, a detailed filter scan record can be maintained that records all of the data that was erased during any and all rewind procedures so that an auditor or supervisor can review the entire record of any given filter scan including portions erased during any rewind procedure. Monitoring of the detailed filter scan record could detect abuses in use of the rewind procedure. A normal filter scan would also be maintained in which the rewind scan filter data is removed.

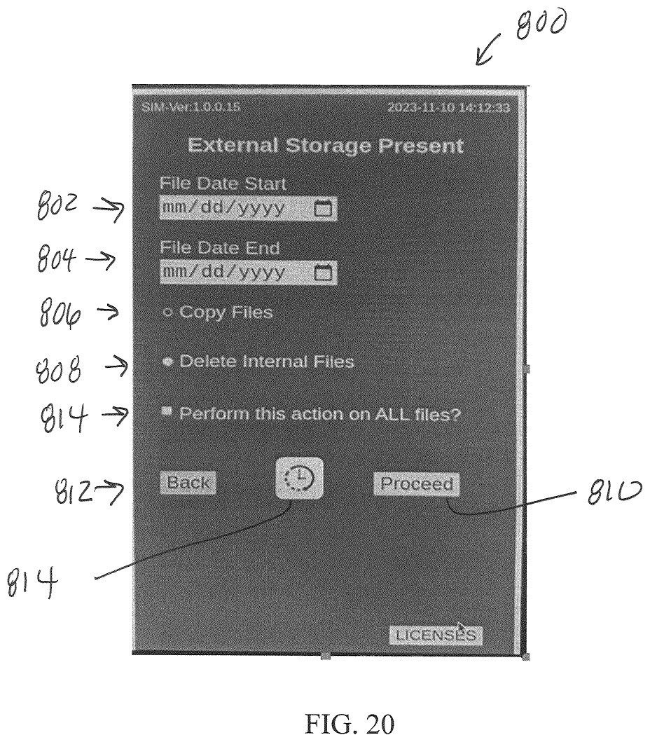

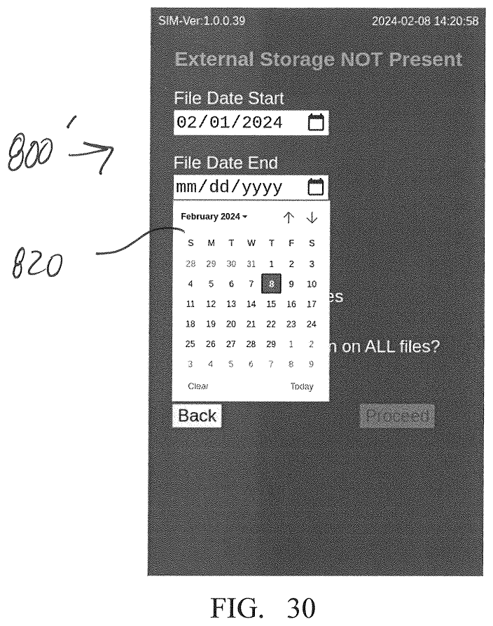

By activating file folder icon 324 on any screen in which it appears (see, for example, FIG. 14), the display of the handheld probe is populated with screen 800 (see FIG. 20). The user sets a start date by touching icon 802 and an end date by touching icon 804. When icon 804 is activated, an interactive drop down calendar is displayed on screen 800 similar or the same as interactive drop down calendar 820 appearing on screen 800′ (see FIG. 30) allowing the user to set a specific end date. When icon 802 is activated by a user touching this icon, a drop calendar similar to or the same as calendar 820 is displayed on screen 800 allowing the user to set a specific start date. The up and down interactive arrows appearing to the right of the month and year section, allow the user to change the month and year.

If the user designates or selects icon 806 on screen 800 by touching icon 806, the user can copy to an external USB stick or drive all files from the designated start date to the designated end date by touching “Proceed” box 810. After designating or selecting icon 808, the user can delete all internal files stored in the memory of the handheld probe 210 from the designated start date to the designated end date by touching “Proceed” box 810. If the user activates the “Back” box 812, the user is automatically returned to the screen from which the user accessed screen 800. Screen 800 may also include interactive icon or graphical element 814 to have the selected function (i.e., copying or deleting) performed on all files.

Screen 800′ (see FIG. 30) is similar to screen 800 and is displayed when a user activates file folder icon 324 and no external USB stick or drive is connected to socket 240 informing the user in the title of this interactive screen that “External Storage NOT Present”. The copying function in screen 800′ is disabled and greyed out.

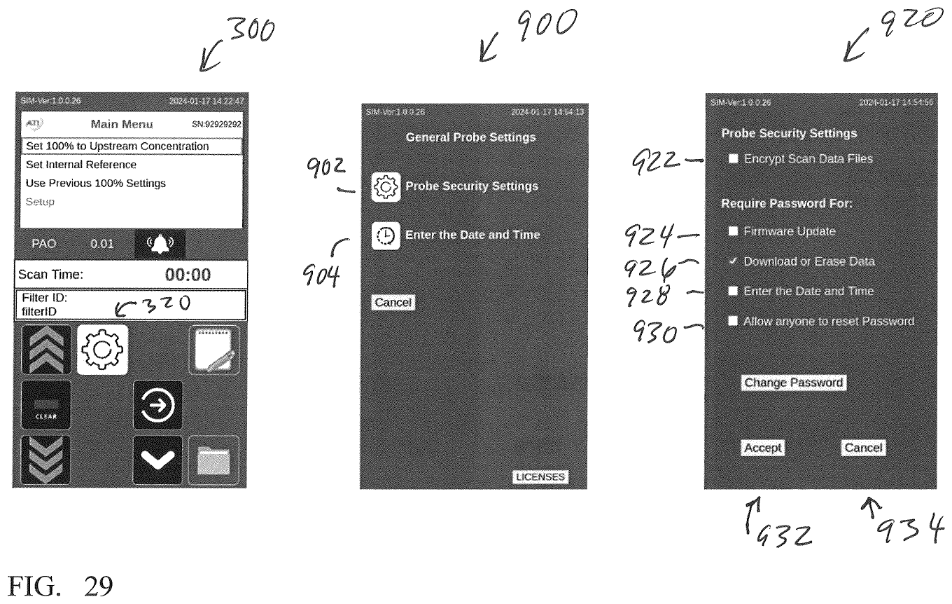

The functions that a user can perform by activating the Admin icon 320 on any screen in which appears will be described in connection with FIG. 29. Specifically, the user can select touch or tap on icon 320 to update security settings. Upon activation of icon 320, the display of the handheld probe is populated with interactive screen 900 (see FIG. 29). Tapping or touching the Probe Security Settings icon 902 of screen 900 populates the display of the handheld probe with interactive screen 920. Interactive clock icon 904 on screen 900 when activated allows the user to change the date and time. If screen 900 includes clock icon 904 then the clock icon on screen 814 on screen 800 can be omitted. If the date and time has been password protected, the user will be challenged for the password. The “Encrypt Scan Data Files” selectable item 922 under the heading “Probe Security Settings” of screen 920 when checked or selected by tapping on the corresponding box will cause all scan data files to be encrypted before they are copied to an external USB stick or drive. The password needed to decode these encrypted files can be set as the admin password. Under the heading “Require Password For:”, four selectable items 924 (“Firmware Update”), 926 (“Download or Erase Data”), 928 (“Enter the Date and Time”) and 930 (“Allow anyone to reset Password”) can be designated or selected by tapping on the corresponding box and the user will be required to enter a password to perform any of the functions associated with any of items 924, 926, 928 and 930 that are password protected. All selections or designations made using screen 920 are implemented upon activation of the “Accept” box 932. Activation of the “Cancel” box 934 on screen returns the user to screen 300 as does the activation of the “Cancel” box on screen 900.

While each of the screens or user interfaces described above have icons or activation members in certain portions of the screen (e.g., lower portion, upper portion and middle portion), the location of the activation members or icons can be varied as desired. For example, on screen 900 the “Allow anyone to reset Password” 930 icon could appear at the top of screen 900.

While this invention has been described as having various preferred designs, it is understood that the preferred designs can be further modified or adapted following in general the principles of the invention and including, but not limited to such departures from the present invention as come within the known or customary practice in the art to which the invention pertains. The claims are not limited to the preferred embodiments and have been written to preclude such a narrow construction using the principles of claim differentiation.

We claim:

1. An apparatus for testing a filter, said apparatus comprising:
(a) a handheld probe for testing a filter, said handheld probe being configured to be deployed adjacent the filter being tested while the filter being tested is located in a normal operating position; and,
(b) said handheld probe further including a display for displaying one or more graphical user interfaces to the user, each of the one or more graphical user interfaces having one or more interactive icons that a user can activate to perform a predetermined operation in connection with testing the filter.

2. The apparatus of claim 1, wherein:
(a) all activation members on the handheld probe which a user can manipulate or activate to perform any operation or function using the handheld probe are virtual activation members.

3. The apparatus of claim 1, wherein:
(a) the apparatus is configured to display to a user a first graphical user interface having a rewind or trim interactive activation icon that when activated by the user during a filter scan can erase a predetermined time period of a filter scan performed using the handheld probe to prevent an event that is not indicative of filter efficiency or leakage from resulting in a false failure of a filter being tested.

4. The apparatus of claim 3, wherein:
(a) the apparatus is configured such that upon activation of the rewind or trim interactive activation icon, the display presents to the user a rewind or trim activation window asking the user whether or not a rewind or trim function is to be performed.

5. The apparatus of claim 4, wherein:
(a) the apparatus is configured such that upon activation of the rewind or trim activation interactive icon and the user interacts with the rewind or trim activation window to decline a corresponding function, a given filter scan proceeds without interruption with all filter scan data being collected for a given filter scan that would have been collected if the rewind or trim activation interactive icon was never activated.

6. The apparatus of claim 4, wherein:
(a) the apparatus is configured such that upon activation of the rewind or trim interactive activation icon and the user interacts with the rewind or trim activation window to accept a corresponding function, a predetermined time period of the filter scan is erased and the apparatus is automatically returned to a filter scan mode.

7. The apparatus of claim 4, wherein:
(a) the apparatus is configured such that upon activation of the rewind or trim activation interactive icon, a time of activation of the rewind or trim activation interactive icon is recorded so that if the user interacts with the rewind or trim activation window to accept performance of a rewind or trim, a period of the scan erased is a predetermined time period from a time of activation of the rewind or trim interactive activation icon to a current time.

8. The apparatus of claim 6, wherein:
(a) the predetermined time period is less than 20% of a time period necessary to perform a complete filter scan of a filter being tested.

9. The apparatus of claim 6, wherein:
(a) the predetermined time period is in the range of 5 to 30 seconds.

10. The apparatus of claim 6, wherein:
(a) the predetermined time period is 10 seconds.

11. An apparatus for testing a filter, said apparatus comprising:
(a) a handheld probe for testing a filter and a base unit, said handheld probe being operably connected to said base unit and being configured to be deployed adjacent the filter being tested while the filter being tested is located in a normal operating position; and,
(b) at least one of said handheld probe and said base unit including a user activation portion including one or more user activation members that a user can activate to perform a predetermined operation or function in connection with testing the filter; and,
(c) said one or more user activation members including a rewind or trim activation member that when activated during a filter scan can erase a predetermined time period of the filter scan being performed to prevent an event that is not indicative of filter efficiency or leakage from resulting in a false failure of a filter being tested.

12. The apparatus of claim 11, wherein:
(a) the one or more user activation members are a virtual activation member or a physical activation member.

13. The apparatus of claim 12, wherein:
(a) the rewind or trim activation member is a virtual activation member or a physical activation member.

14. The apparatus of claim 13, wherein:
(a) the rewind or trim activation member is a physical activation member on the handheld probe or the base unit.

15. A method of testing a filter, said including the steps of:
(a) providing a handheld probe and a base unit for testing a filter wherein during a filter scan the handheld probe is operably connected to the base unit, said handheld probe being configured to be deployed adjacent the filter being tested while the filter being tested is located in a normal operating position; and,
(b) providing at least one of said handheld probe and said base unit with a rewind or trim activation member; and,
(c) upon activation of the rewind or trim activation member, erasing a predetermined time period of a filter scan performed using the handheld probe to prevent an event that is not indicative of filter efficiency or leakage from resulting in a false failure of a filter being tested wherein the predetermined time period is less than a time necessary to scan a filter being tested.

16. The method of claim 15, further including the step of:
(a) displaying the rewind or trim activation member as an interactive icon on a graphical user interface on a display of the handheld probe or the base unit.

17. The method of claim 16, further including the step of:
(a) displaying the rewind or trim activation member as an interactive icon on a graphical user interface on the display of the handheld probe.

18. The method of claim 17, further including the step of:
(a) upon user activation of the rewind or trim activation member, displaying a rewind or trim activation graphical element asking the user whether or not a rewind or trim function is to be performed.

19. The method of claim 18, further including the step of:
(a) upon receiving user input that the rewind or trim function is to not performed, performing a filter scan as if the rewind or trim activation member was never activated.

20. The method of claim 18, further including the step of:
(a) upon receiving user input that the rewind or trim function is to be performed, deleting all scan data from a time the rewind or trim activation member was activated for a first data record; and,
(c) automatically returning to a filter scan mode.
